(19) United States
(12) Patent Application Publication
(10) Pub. No.: US 2026/0094134 A1
(43) Pub. Date: Apr. 2, 2026

(54) BEI CLAWBACK CONTROL PLANE WITH METRICS-DRIVEN ROLLBACK ENERGY AND STANDARDIZED EXECUTION INTERFACES

(71) Applicant: FURONG BEI, SAN GABRIEL, CA (US)

(72) Inventor: FURONG BEI, SAN GABRIEL, CA (US)

(21) Appl. No.: 19/412,900

(22) Filed: Dec. 9, 2025

Related U.S. Application Data
(63) Continuation-in-part of application No. 19/056,745, filed on Feb. 19, 2025.
(63) Continuation-in-part of application No. 19/060,663, filed on Feb. 22, 2025.
(63) Continuation-in-part of application No. 19/067,732, filed on Feb. 28, 2025.
(63) Continuation-in-part of application No. 19/059,110, filed on Feb. 20, 2025, now abandoned.
(63) Continuation-in-part of application No. 19/084,806, filed on Mar. 20, 2025.
(63) Continuation-in-part of application No. 19/069,257, filed on Mar. 4, 2025.
(63) Continuation-in-part of application No. 19/072,075, filed on Mar. 6, 2025.
(63) Continuation-in-part of application No. 19/073,574, filed on Mar. 7, 2025, now abandoned.
(63) Continuation-in-part of application No. 19/094,730, filed on Mar. 28, 2025.
(63) Continuation-in-part of application No. 19/067,936, filed on Mar. 2, 2025.

(51) Int. Cl. G06Q 20/06

(52) U.S. Cl. CPC G06Q 20/065

(57) ABSTRACT

A clawback control system and method are disclosed for an identity-anchored ledger infrastructure that maintains a tri-ledger comprising a currency ledger, an index ledger, and an energy ledger for events associated with Behavioral Economics Identities (BEI). A clawback orchestration node ingests data derived from the tri-ledger and computes segment-level metrics including dispute rates, fraud loss rates, refund latency, compliance scores, time-to-identity, time-to-store, and energy-per-operation. Using these metrics together with a rollback energy budget recorded as Financial and Regulatory Rollback Energy (FR2), the orchestration node determines clawback actions for disputed or anomalous events. A legal execution node transforms each clawback action into standardized clawback instructions compatible with external infrastructures such as bank or ACH systems, card networks, distributed ledgers, and central bank digital currency platforms. A treasury node executes compensating transfers from reserve pools and updates the tri-ledger accordingly. An audit log stores digitally signed case records, enabling verifiable evidence for courts and regulators while supporting anonymized aggregation of city-, region-, or nation-level metrics.

### CROSS-REFERENCE TO RELATED APPLICATIONS

This application is a Continuation-in-Part (CIP) of the following U.S. patent applications, each commonly owned and each incorporated by reference in its entirety pursuant to 37 C.F.R. Section 1.57 and 35 U.S.C. Section 120. The applications listed in Section A are relied upon for priority, and the applications listed in Section B are incorporated by reference but are not relied upon for priority. Corresponding continuity data will be provided in the Application Data Sheet (ADS).

### A. Priority Parents (Relied Upon for Priority)

U.S. application Ser. No. 19/056,745, filed Feb. 19, 2025.

U.S. application Ser. No. 19/060,663, filed Feb. 22, 2025.

U.S. application Ser. No. 19/067,732, filed Feb. 28, 2025.

U.S. application Ser. No. 19/074,326, filed Mar. 8, 2025.

U.S. application Ser. No. 19/084,790, filed Mar. 20, 2025.

U.S. application Ser. No. 19/073,574, filed Mar. 7, 2025.

U.S. application Ser. No. 19/086,144, filed Mar. 21, 2025.

U.S. application Ser. No. 19/094,730, filed Mar. 28, 2025.

U.S. application Ser. No. 19/072,075, filed Mar. 6, 2025.

### B. Related Applications Incorporated by Reference (Not Relied Upon for Priority)

U.S. application Ser. No. 19/374,710, filed Oct. 30, 2025 (BEIMONETARY).

U.S. application Ser. No. 19/406,982, filed Dec. 3, 2025 (BEI Anchor-Based Reversible Clearing and Payment System with ATMS Global Terminals and BEI Currency Infrastructure).

U.S. application Ser. No. 19/403,793, filed Dec. 2, 2025 (Civilization-Scale Behavioral Economics Identity (BEI) Securities Infrastructure with Time-Land Cadastral Namespace, BEISIGN Authorization, DR. AIR Oversight, and BEIFR2 Rollback).

U.S. application Ser. No. 19/405,426, filed Dec. 2, 2025 (BEI Behavioral Economics Identity Currency System with Sovereign Standard Family and Multi-Head Rectification Governance).

U.S. application Ser. No. 19/059,110, filed Feb. 20, 2025 (Global Financial Network Platform (ATMS. com) for Integrated Payment, Settlement and Clearing).

U.S. application Ser. No. 19/398,033, filed Nov. 24, 2025 (BEI Civilization Engine: Computer-Implemented Multi-System Domain Parcel Connectivity Framework for Global Sovereign Identity, Currency, and Resource Generation).

U.S. application Ser. No. 19/392,803, filed Nov. 18, 2025 (BEI Sovereign Operating System: Time-Grid, Behavioral Economics Identity, and Identity-Indexed Financial Stack).

U.S. application Ser. No. 19/394,827, filed Nov. 19, 2025 (Genesis Currency System: BEI Behavioral Economics Identity Currency Based on Identity, Time and Life Value).

U.S. application Ser. No. 19/388,360, filed Nov. 13, 2025 (BEI Reserve Human Sovereign Reserve System and Method Based on Behavioral Economics Identity).

U.S. application Ser. No. 19/370,475, filed Oct. 27, 2025 (BEI Behavioral Economic Identity Universal Sovereign Infrastructure).

U.S. application Ser. No. 19/373,598, filed Oct. 29, 2025.

U.S. application Ser. No. 19/372,269, filed Oct. 29, 2025.

U.S. application Ser. No. 19/053,450, filed Nov. 1, 2025.

U.S. application Ser. No. 19/053,406, filed Nov. 1, 2025.

U.S. application Ser. No. 19/376,896, filed Nov. 1, 2025.

U.S. Publication No. 2025/0209466 A1, published Jun. 26, 2025.

U.S. Publication No. 2025/0259241 A1, published Aug. 14, 2025.

U.S. application Ser. No. 19/411,327, filed Dec. 7, 2025.

U.S. application Ser. No. 19/411,367, filed Dec. 7, 2025.

U.S. application Ser. No. 19/412,081, filed Dec. 8, 2025.

U.S. application Ser. No. 19/412,863, filed Dec. 9, 2025.

To the extent not inconsistent herewith, the disclosures of the above-listed applications and publications are incorporated by reference in their entirety. Applicants will ensure that the Application Data Sheet (ADS) reflects the foregoing continuity relationships and that these documents are identified on the Information Disclosure Statement (PTO/SB/08a).

### TECHNICAL FIELD

The invention relates to computerized governance of digital events and value flows. More particularly, it concerns a metrics-driven clawback and correction control plane for Behavioral Economics Identity (BEI) systems, enabling reversible, energy-bounded clawback operations across financial, healthcare, educational, and other sectors.

### BACKGROUND

Existing digital transaction systems treat corrections and refunds as peripheral processes:
Chargebacks and disputes are handled by manual workflows and heterogeneous rules at card schemes, banks, and platforms.
Consumer-protection regulations are applied ex post, with limited visibility into systemic risk.
Identity, value, and risk information are stored in separate silos, making it difficult to apply consistent policies.

In parallel, identity frameworks and new forms of currencies—including loyalty points and tokens—have evolved without a unified, protocol-level mechanism for:
linking events to behavioral identities,
measuring system-wide integrity and risk, and
executing reversible corrections constrained by explicit resource budgets.

The inventor's prior work on BEI, ATMS, and tri-ledger fee-to-mint systems defines:
a sovereign identity layer (BEI/BEIDID/Digital Deeds), and
a sovereign value layer (BEIMINT/BEICURRENCY/tri-ledger),
   but lacks a dedicated sovereign correction and clawback layer that:
1. continuously measures system metrics from identity and value layers;
2. associates each event with rollback energy; and
3. coordinates legal execution and treasury backstops for clawback actions across infrastructures.

There is therefore a need for a metrics-native clawback control plane that operates on BEI-anchored events, integrates with existing networks, and provides civilization-scale, reversible governance for approximately 8.3 billion individuals.

### SUMMARY OF THE INVENTION

The embodiments described herein provide a clawback control plane for an identity-anchored ledger infrastructure that maintains, for events associated with Behavioral Economics Identities (BEI), a tri-ledger comprising a currency ledger, an index ledger, and an energy ledger. Rather than treating disputes and refunds as ad hoc, manual processes, the disclosed system introduces a metrics-driven orchestration layer that continuously evaluates system behavior and allocates a bounded rollback energy budget recorded as Financial and Regulatory Rollback Energy (FR2). This enables clawback decisions to be executed in a standardized and auditable manner while preserving systemic stability.

In one aspect, a clawback orchestration node ingests data derived from the tri-ledger and computes segment-level metrics for identities, merchants, platforms, sectors, and jurisdictions. The metrics may include dispute rates, fraud loss per fixed number of events, refund resolution latency, compliance scores, time-to-identity, time-to-store, and energy-per-operation. Using these metrics together with FR2 values recorded in the energy ledger, the orchestration node determines one or more clawback actions for disputed or anomalous events, such as full or partial refunds, reversals, freezes, escalations to manual review, or explicit denials of requested relief.

In another aspect, a legal execution node, referred to as BEICLAW, transforms each clawback action into a standardized clawback instruction that conforms to at least one canonical schema. The standardized instructions are suitable for execution by external infrastructures such as bank or automated clearing house systems, card networks, distributed ledger or blockchain networks, and central bank digital currency platforms. A treasury node, referred to as BEIBACK, manages reserve pools of fiat currency, BEI currency, or tokenized assets and performs compensating transfers that implement the clawback actions while updating the currency ledger, index ledger, and energy ledger.

In some embodiments, each event recorded in the tri-ledger is associated with a multi-head confirmation object, or Tri-Header, that aggregates cryptographic signatures from a payer terminal, a merchant terminal, and a network or regulator node, and optionally from sector-specific nodes. The clawback orchestration node can require successful verification of the Tri-Header before authorizing a clawback action, thereby anchoring each correction to a verifiable record of the underlying transaction. The energy ledger records BFR and FR2 balances at an event or segment level, and FR2 balances are debited when rollback operations are executed, enforcing an explicit energy cost for corrections.

In further aspects, an audit log separate from the tri-ledger stores digitally signed case records for executed clawback actions, including metric snapshots and identifiers of the legal and treasury nodes involved. These case records are exportable as evidence for courts, regulators, or external dispute resolution systems. The same data sources can be aggregated into anonymized city-, region-, or nation-level metrics that inform policy and oversight without exposing individual BEI identifiers. The disclosed subject matter can be implemented as systems, computer-implemented methods, and non-transitory computer-readable media storing instructions that configure processors to perform the described operations.

The invention thus provides a technical framework in which dispute handling and clawback execution are integrated with identity-anchored ledgers, explicit rollback energy accounting, and standardized interfaces to external financial infrastructures. This enables scalable, auditable, and policy-driven correction of value flows across diverse payment and non-payment domains, while supporting commercialization, licensing, and integration into larger sovereign financial and regulatory ecosystems.

### BRIEF DESCRIPTION OF THE DRAWINGS

FIG. 1 is a block diagram illustrating a three-layer sovereign architecture including a sovereign identity layer, a sovereign value layer, and a sovereign correction and clawback layer implementing BEICLAWBACK, BEICLAW, BEIBACK, and an energy ledger.

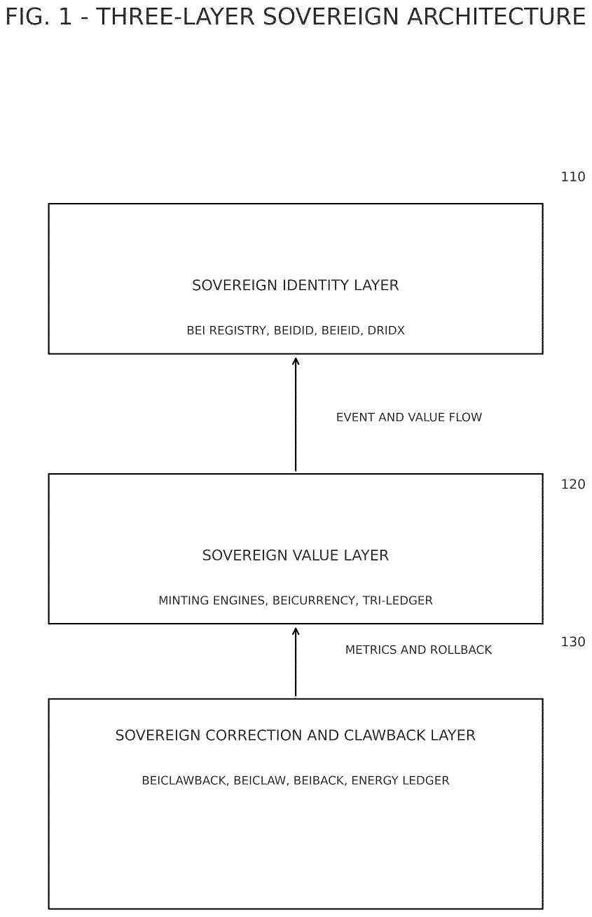

FIG. 2 is a schematic diagram illustrating ingestion of tri-ledger data by a clawback orchestration node and computation of system metrics including dispute rate, fraud loss, refund latency, compliance score, time-to-identity, time-to-store, and energy-per-operation.

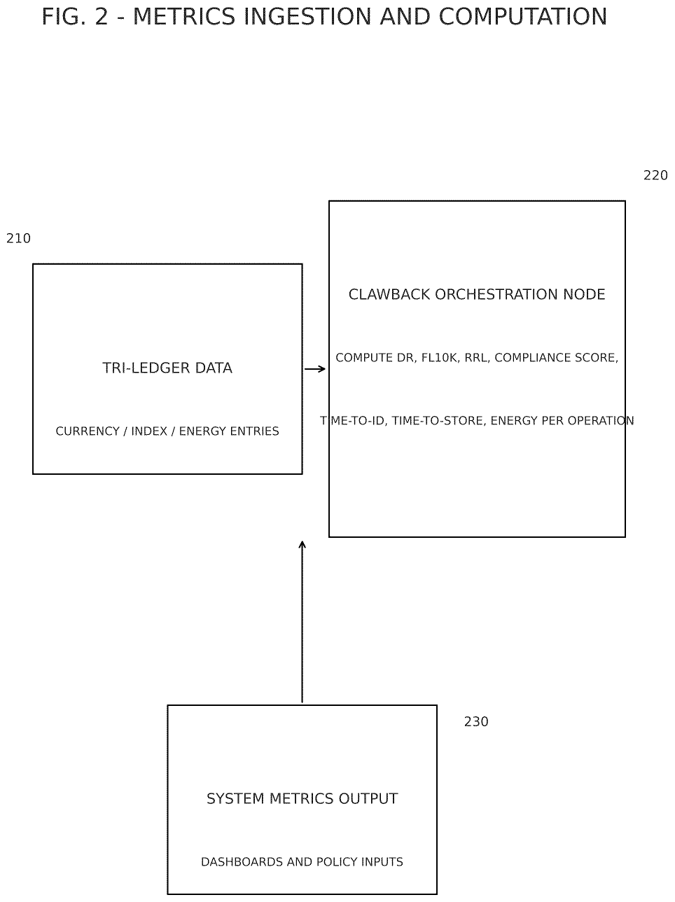

FIG. 3 is a diagram illustrating multi-head confirmation, in which a payer terminal, a merchant terminal, and a network or regulator node generate signatures that form a Tri-Header confirmation object linked to tri-ledger entries.

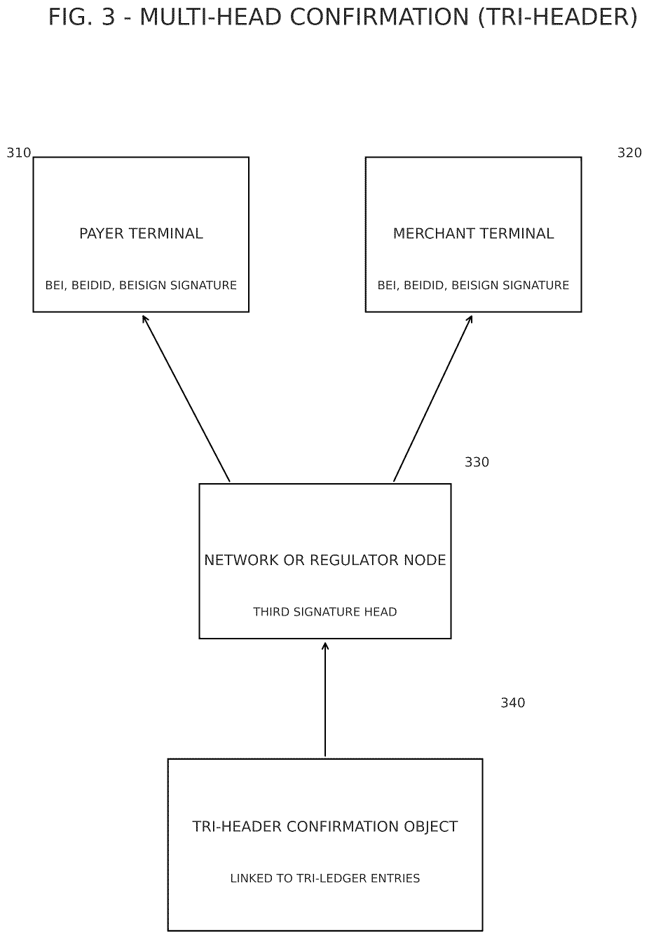

FIG. 4 is a flow diagram illustrating a dispute and clawback process from a user or regulator through the clawback orchestration node to a legal execution node (BEICLAW) and a treasury node (BEIBACK).

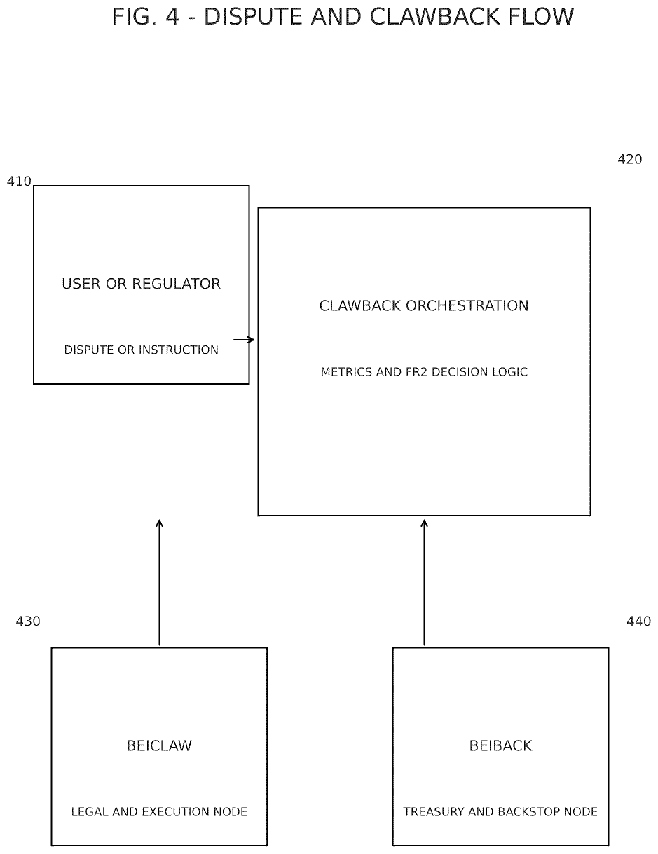

FIG. 5 is a schematic representation of an energy ledger that records Behavioral Field Resource (BFR) and Financial and Regulatory Rollback Energy (FR2) balances and shows consumption of FR2 during rollback operations.

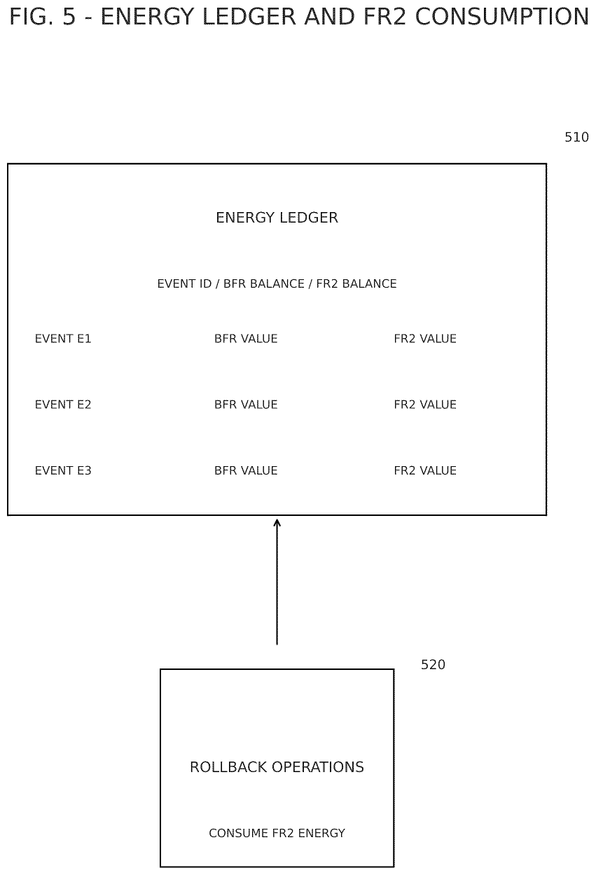

FIG. 6 is a block diagram illustrating integration of a BEICLAW node with external infrastructures including a bank or ACH system, a card network, a distributed ledger or blockchain network, and a central bank digital currency platform.

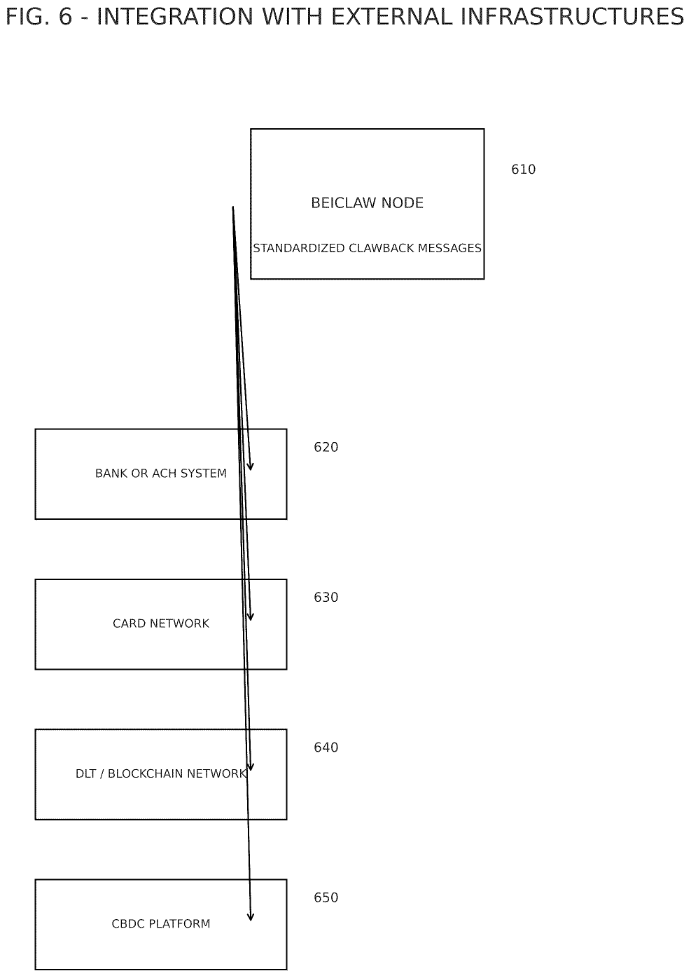

FIG. 7 is a diagram illustrating anonymized aggregation of tri-ledger and audit-log data into city-level, region-level, and nation-level metrics for external analysis or policy systems without exposing individual BEI identifiers.

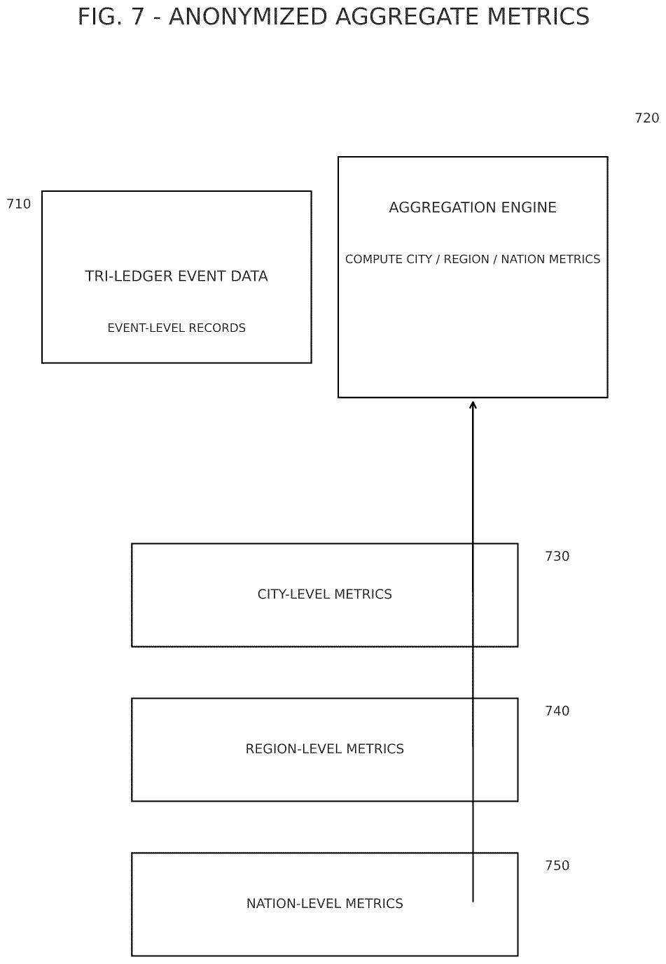

FIG. 8 is a schematic example of a user journey showing identity issuance, store onboarding, transaction with tri-ledger and Tri-Header recording, dispute initiation, and clawback and compensation handled by BEICLAWBACK, BEICLAW, and BEIBACK.

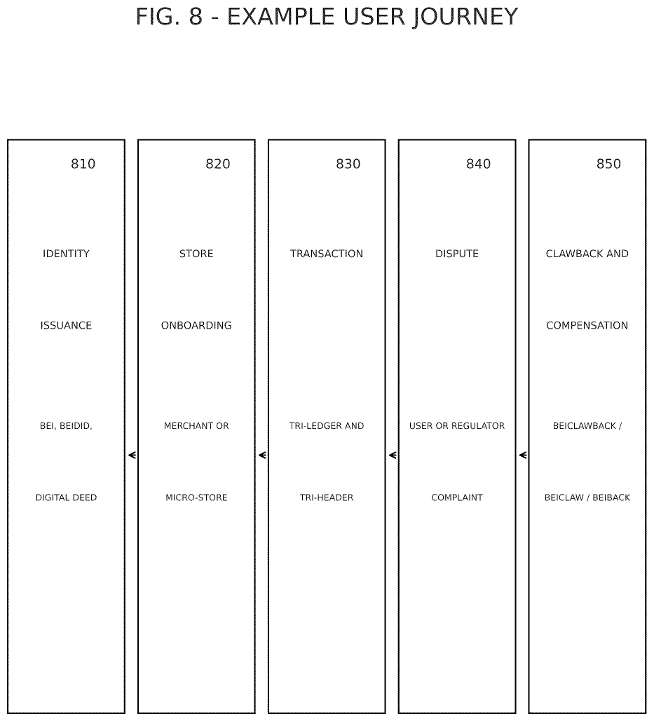

### DETAILED DESCRIPTION OF EMBODIMENTS

### 1. Sovereign Identity Layer

In one embodiment, a sovereign identity registry maintains BEI records for individuals, households, merchants, institutions, and devices. Each BEI record contains:
a BEI identifier;
one or more BEIDIDs (decentralized identities);
a set of BEIEIDs representing events associated with the BEI;
a DRIDX record linking:
   geographic region,
   sector (e.g., finance, health, education),
   Digital Deeds (domain-based land parcels), and
   time-domain deeds such as hour-, day-, week-, and year-level subdomains (for example under hour. us, days. us, week. us, year. us).

The identity registry can be implemented as:
a distributed ledger,
a replicated database cluster, or
a hybrid of both.

The registry exposes read/write APIs for internal components and read-only, privacy-filtering APIs for auditors and regulators.

### 2. Sovereign Value Layer and Tri-ledger

The sovereign value layer comprises one or more minting engines (for example, BEIMINT) and tri-ledger storage:

### 1. Beicurrency Ledger

Records balances and flows of BEICURRENCY and related instruments. Each entry is associated with:
BEI identifier(s),
BEIEID,
DRIDX and time-domain deed references,
amounts in various BEICURRENCY categories.

### 2. Bei Index Ledger

Records index values describing behavioral-economic status of BEIs and aggregates, such as:
trustworthiness,
resiliency,
sectoral engagement,
health, education, or environmental scores.

### 3. Energy Ledger

Records BFR (Behavioral Field/Force Resource) and FR2 (Financial & Regulatory Rollback Energy) quantities at:
event level,
BEI level,
domain/sector level.

The tri-ledger may be implemented with:
separate logical databases,
a single physical data store with type tags, or
a distributed ledger infrastructure with merkle-tree commitments.

The prior fee-to-mint invention defines in detail how value enters the tri-ledger. The present invention assumes that such events have been recorded and focuses on how to govern and correct them.

### 3. Metrics-Driven Clawback Orchestration (BEICLAWBACK)

The clawback orchestration node (sometimes referred to as BEICLAWBACK) is a logical component that performs at least the following functions.

### 3.1 Ingests Data

Subscribes to tri-ledger updates (BEICURRENCY, BEI index, energy).
Receives dispute tickets from users, platforms, and regulators.
Receives environmental signals (e.g., incident reports, macro-risk alerts).

### 3.2 Computes Metrics

For a given scope (BEI, merchant, platform, region, or sector), the node computes:
Dispute Rate (DR)—ratio of disputed events to total events.
Fraud Loss per Ten Thousand Events (FL₁₀)—financial loss at a standard scale.
Refund Resolution Latency (RRL)—average time from dispute to closure.
Compliance Score (CS_reg) —derived from:
   number of violations;
   number of late reports;
   resolution quality.
Time-to-Identity (TTID)—time to issue a usable BEI identity.
Time-to-Store (TTS)—time to onboard a merchant or micro-store.
Energy-Per-Operation (E_op)—average FR2/BFR cost per tri-ledger write.

### 3.3 Evaluates Candidate Actions

When a dispute or regulatory instruction arrives, the node:
identifies affected events via BEIEIDs, DRIDX, and time-domain deeds;
reads associated BEICURRENCY entries, index contributions, and FR2 quantities;
generates candidate actions, including:
   full monetary rollback;
   partial rollback;
   non-monetary corrections (index adjustment, warning);
   denial of relief; or
   staged rollback contingent on future behavior;
checks whether each candidate action is permitted by:
   FR2 energy budgets,
   jurisdictional policies, and
   compliance thresholds.

### 3.4 Issues Decisions

The selected action is encoded in a clawback decision object, comprising:
identifiers of affected BEIs and accounts;
amounts to be reversed, reallocated, or compensated;
FR2 energy to be consumed;
case identifiers and deadlines for execution.

The decision object is then:
forwarded to BEICLAW for legal translation and messaging; and
forwarded to BEIBACK for treasury planning.

### 4. Legal and Execution Node (BEICLAW)

The legal and execution node performs at least the following functions.

### 4.1 Maintains Case Records

Each case has a unique case ID linked to:
one or more BEIEIDs,
dispute tickets,
Tri-Header confirmation objects,
FR2 energy budgets.

### 4.2 Generates Standardized Messages

For each approved decision, BEICLAW:
translates instructions into message formats required by:
   bank and card networks (e.g., ISO 20022, ISO 8583 variants),
   distributed ledgers (smart contract calls),
   CBDC platforms (central bank APIs),
   internal BEI/ATMS ledgers;
signs or seals these messages with appropriate keys.

### 4.3 Tracks Execution

Receives acknowledgments from external networks.
Updates case records with success, partial success, or failure statuses.
Notifies BEICLAWBACK and BEIBACK of execution results.

### 4.4 Provides Audit Trails

Exposes privacy-filtered case summaries for regulators.
Produces cryptographic commitments over batches of decisions and outcomes.
Enables later forensic verification.

### 5. Treasury Node (BEIBACK)

The treasury node (BEIBACK) manages risk and compensation.

### 5.1 Reserve Pools

The node maintains one or more pools comprising:
fiat currencies;
BEICURRENCY units;
tokenized carbon credits, health credits, or other instruments;
insurance or reinsurance arrangements.

### 5.2 Backstop and Buyback Operations

When a clawback decision requires payment to an affected BEI and direct reversal against a counterparty is slow or uncertain, BEIBACK may:
perform an immediate backstop payment to the victim BEI;
record a recovery obligation against the counterparty BEI or institution;
optionally purchase or buy back certain BEICURRENCY or NFTs at predefined floors.

### 5.3 Coordination With FR2 Energy

The treasury node consults FR2 records before initiating large or repeated payouts.
The node adjusts pricing, premiums, or pool composition based on consumption patterns of FR2 and observed DR/FL₁₀ metrics.

### 5.4 Reporting

Provides aggregate reports on pool solvency, payout ratios, and recovery performance.
Feeds data back into BEICLAWBACK for metric updates.

### 6. Multi-Head Confirmation (Tri-Header)

In one embodiment, each event subject to potential clawback is linked to a multi-head confirmation object:
1. Payer Head
   Generated by a user terminal (BEIDID holder) via a BEISIGN operation within a secure enclave.
2. Payee Head
   Generated by a merchant, institution, or service provider terminal.
3. Network/Regulator Head
   Generated by a clearing node, platform operator, or regulator.

Optionally, additional heads are attached by:
a healthcare authority (for medical claims),
an educational accreditation body,
an environmental registry, or
other sector observers.

The multi-head object is:
stored in a confirmation log;
referenced by tri-ledger entries;
referenced by case records in BEICLAW.

During a dispute, the Tri-Header is used as:
cryptographic evidence of who consented to what;
a feature vector for decision models;
a basis for allocating accountability and FR2 costs.

### 7. Example Use Cases

### 7.1 Payment Fraud Case

1. A user is tricked into paying a fraudulent merchant.
2. The event is recorded in the tri-ledger; BEICURRENCY and FR2 units are minted.
3. The user files a dispute via an ATMS or BEI application.
4. BEICLAWBACK:
   pulls tri-ledger and Tri-Header data;
   computes updated DR and FL₁₀ for the merchant and platform;
   determines that a full rollback is justified and FR2 energy is sufficient.
5. BEICLAW sends standardized clawback messages to the card network and bank.
6. BEIBACK pays the user immediately from a reserve pool while recovery from the merchant is pending.
7. FR2 units are consumed; BEI index scores for the merchant are downgraded; aggregate metrics for the platform and region are updated.

### 7.2 Healthcare Over-billing Case

1. A hospital repeatedly charges unnecessary procedures.
2. Healthcare claims are linked to BEIEIDs and Tri-Headers including signatures from a health registry node.
3. Periodic analytics show abnormal patterns in DR, FL₁₀, and RRL for the hospital's DRIDX entry.
4. A regulator initiates an investigation and instructs BEICLAWBACK to evaluate clawback scenarios.
5. BEICLAWBACK simulates partial and full clawbacks, constrained by FR2 energy and treasury capacity.
6. A staged clawback plan is adopted:
   immediate partial refunds to patients via BEIBACK;
   scheduled clawbacks from hospital accounts;
   mandatory index downgrades and compliance conditions.

### 7.3 Education Refund Case

1. An online course provider fails to deliver promised content.
2. Students raise disputes; Tri-Headers show ambiguous or missing provider signatures.
3. Metrics indicate a spike in DR and a sharp drop in completion rates.
4. The control plane:
   denies further admissions by tightening an admission gate;
   authorizes partial refunds funded by the provider's prior BEICURRENCY earnings and BEIBACK reserves;
   records the provider's behavior in the BEI index ledger, visible to future learners and regulators.

### 8. Implementation Variants

The control plane may be implemented as:
a centralized service operated by a consortium or foundation;
a Federated Network of BEICLAWBACK, BEICLAW, and BEIBACK Nodes in Different regions;
a smart-contract layer on one or more distributed ledgers.

Endpoints for the nodes may be exposed at domain names such as:
beiclawback.com for orchestration APIs;
beiclaw.com for legal/case interfaces;
beiback.com for treasury/reporting interfaces;
behaviormint.org for related standards and metrics documentation.

These domain examples are illustrative; the invention is not limited to any specific DNS names.

### 9. Industrial Applicability

The invention is applicable to:
global and regional payment networks;
banks and fintechs seeking standardized clawback mechanisms;
healthcare systems and insurers managing fraudulent or abusive claims;
education platforms implementing fair refund rules;
regulators needing real-time insight into systemic risk and consumer protection.

By providing a metrics-driven, energy-bounded, identity-anchored clawback layer, the invention upgrades digital economies from ad hoc refund processes to a civilizational control infrastructure that can be licensed, standardized, and integrated into large-scale asset portfolios and SPAC structures.

### APPENDIX TO SPECIFICATION

An appendix to this specification, entitled “APPENDIX TO SPECIFICATION—RELATED BEI×BEI GALAXY×ATMS×DOMAIN-BASED ECOSYSTEM FILINGS,” is submitted herewith. The appendix provides a consolidated list of approximately three hundred eighty (380) related U.S. and international patent applications filed by the present inventor and commonly owned entities, and is incorporated herein for technical background and ecosystem context. The applications listed in the appendix may have various prosecution statuses (including pending, allowed, issued, or abandoned), but are identified to show the broader technical landscape and continuity of development of the BEI and ATMS ecosystems.

In addition, in some embodiments a further appendix to this specification may be prepared, entitled “APPENDIX—DOMAIN-NAME PORTFOLIO FOR BEI×BEI GALAXY×ATMS ECOSYSTEM. ” Such an appendix, if filed in connection with this application or a related application, would set forth a portfolio list of approximately two thousand eight hundred (2,800) unique, system-level domain names associated with the BEI, BEI Galaxy, ATMS, and related ecosystems. These domain names are not merely conventional web addresses; rather, in the disclosed behavioral-economics identity infrastructure they function as ecosystem components, including at least: (a) namespaces and routing endpoints for BEI identities and YueNames; (b) digital land parcels and service nodes within a multi-layer domain fabric; and (c) anchors for material, resource, and asset flows that are represented in the time-ledger and tokenization mechanisms described in this specification. To the extent any such domain-name appendix is filed in connection with this application, it is incorporated herein for technical background and ecosystem context.

Except where an individual application from these lists is expressly identified in the Cross-Reference to Related Applications section and/or in the Application Data Sheet (ADS) as a priority application or domestic benefit application, the applications and materials listed in any appendix are not relied upon for priority or for any claim of domestic benefit or foreign priority in the present application. Identification of such applications, publications, and domain names in an appendix is not an admission that any such document or material constitutes prior art to the present application.

1. A clawback control system for an identity-anchored ledger infrastructure, the system comprising:
a tri-ledger data store configured to maintain, for a plurality of events associated with Behavioral Economics Identities (BEI), a currency ledger, an index ledger, and an energy ledger;
a clawback orchestration node configured to ingest data derived from the tri-ledger data store and to compute, for at least one segment selected from an identity, a merchant, a platform, a sector, and a jurisdiction, a set of metrics representing dispute behavior and system performance;
the clawback orchestration node further configured to evaluate a rollback energy budget recorded in the energy ledger and to determine, based on the metrics and the rollback energy budget, at least one clawback action for at least one event;
a legal execution node configured to transform the at least one clawback action into at least one standardized clawback instruction formatted for execution by an external infrastructure; and
a treasury node configured to perform, responsive to the at least one clawback action, at least one compensating transfer and to cause corresponding updates to the currency ledger, the index ledger, and the energy ledger.

2. The system of claim 1, wherein the currency ledger is a BEI currency ledger that records Behavioral Economics Identity currency balances for BEI accounts, the index ledger records at least one BEI index value per BEI, and the energy ledger records, for each BEI or segment, at least one rollback energy quantity comprising Financial and Regulatory Rollback Energy (FR2).

3. The system of claim 1, wherein the set of metrics computed by the clawback orchestration node comprises at least one of:
a dispute rate,
a fraud loss per fixed number of events,
a refund resolution latency,
a compliance score,
a time-to-identity metric,
a time-to-store metric, and
an energy-per-operation metric.

4. The system of claim 1, wherein the clawback orchestration node is further configured to compute the set of metrics over at least one sliding time window and to maintain separate metric states for at least two of: individual BEI accounts, merchants, platforms, sectors, and jurisdictions.

5. The system of claim 1, wherein the clawback orchestration node is further configured to select the at least one clawback action from a plurality of predefined actions comprising at least one of:
issuing a full refund,
issuing a partial refund,
freezing funds or an account,
reversing at least a portion of a prior transfer,
escalating the event to manual review, and
declining a requested refund,
the selection being performed in accordance with policy rules that reference at least one metric value and at least one rollback energy quantity.

6. The system of claim 1, wherein the legal execution node is configured to encode the standardized clawback instruction according to at least one canonical schema usable by at least one external infrastructure selected from: a bank or automated clearing house system, a card network, a distributed ledger or blockchain network, and a central bank digital currency platform.

7. The system of claim 1, wherein the treasury node maintains at least one reserve pool comprising at least one of fiat currency, Behavioral Economics Identity currency, and tokenized assets, and is configured to perform the at least one compensating transfer from the reserve pool prior to or in parallel with execution of the standardized clawback instruction by the external infrastructure.

8. The system of claim 1, wherein the energy ledger records, for each event and each segment, a rollback energy balance, and wherein the clawback orchestration node is further configured, upon determining the at least one clawback action, to determine a rollback energy cost associated with the at least one clawback action and to cause the energy ledger to be updated to subtract the rollback energy cost from the rollback energy balance.

9. The system of claim 1, further comprising a confirmation subsystem configured to associate each event stored in the tri-ledger data store with a multi-head confirmation object comprising cryptographic signatures from at least a payer terminal, a payee terminal, and a network or regulator node, and wherein the clawback orchestration node is configured to use the multi-head confirmation object when evaluating the at least one clawback action.

10. The system of claim 1, further comprising an audit log separate from the tri-ledger data store, wherein the clawback orchestration node is further configured to create, for each executed clawback action, a case record stored in the audit log, the case record comprising at least:
a snapshot of the set of metrics used to decide the clawback action, an identifier of the legal execution node that generated the standardized clawback instruction, and
an identifier of the treasury node that executed the at least one compensating transfer, the case record being digitally signed and exportable as evidence to at least one of a court, a regulator, or an external dispute resolution system.

11. A computer-implemented method of performing metrics-driven clawback control for an identity-anchored ledger infrastructure, the method comprising:
maintaining, in a tri-ledger data store, a currency ledger, an index ledger, and an energy ledger for events associated with Behavioral Economics Identities;
ingesting, by a clawback orchestration node, data derived from the tri-ledger data store;
computing, by the clawback orchestration node, for at least one segment selected from an identity, a merchant, a platform, a sector, and a jurisdiction, a set of metrics representing dispute behavior and system performance;
reading, by the clawback orchestration node, at least one rollback energy quantity from the energy ledger;
determining, by the clawback orchestration node and based on the set of metrics and the at least one rollback energy quantity, at least one clawback action for at least one event;
generating, by a legal execution node, at least one standardized clawback instruction corresponding to the at least one clawback action;
executing, by at least one external infrastructure responsive to the standardized clawback instruction, at least one transfer affecting an account associated with the at least one event; and
causing, by a treasury node, updates to at least one of the currency ledger, the index ledger, and the energy ledger to reflect the at least one transfer and the at least one rollback energy quantity.

12. The method of claim 11, wherein computing the set of metrics comprises computing at least one of: a dispute rate, a fraud loss per fixed number of events, a refund resolution latency, a compliance score, a time-to-identity metric, a time-to-store metric, and an energy-per-operation metric.

13. The method of claim 11, further comprising computing separate instances of the set of metrics for at least two levels of aggregation selected from: individual BEI accounts, merchants, platforms, sectors, and jurisdictions, and using the separate instances when determining the at least one clawback action.

14. The method of claim 11, further comprising computing, for at least one segment, a rollback energy budget as a function of at least one of historical dispute rates, historical fraud losses, exposure of outstanding obligations, available capital, and a policy-defined risk tolerance, and storing the rollback energy budget as the at least one rollback energy quantity in the energy ledger.

15. The method of claim 11, further comprising, prior to determining the at least one clawback action:
retrieving, for the at least one event, a multi-head confirmation object comprising signatures from at least a payer terminal, a payee terminal, and a network or regulator node;
verifying the multi-head confirmation object; and
using the verified multi-head confirmation object as a condition for authorizing the at least one clawback action.

16. The method of claim 11, wherein causing updates to the currency ledger and the index ledger comprises:
crediting, by the treasury node, a compensation amount to an account of a complaining party;
adjusting, in the currency ledger, a corresponding liability of at least one of a merchant, a platform, or a pooled reserve; and
updating, in the index ledger, at least one BEI index value reflecting dispute behavior of at least one of the parties.

17. The method of claim 11, wherein the events maintained in the tri-ledger data store comprise at least one non-payment event selected from: a healthcare claim event, an education enrollment or completion event, a telecommunications billing event, and an environmental usage event, and wherein the at least one clawback action comprises at least one of cancelling a non-monetary entitlement, adjusting a recorded entitlement, and issuing a compensating credit.

18. A non-transitory computer-readable medium storing instructions that, when executed by at least one processor, cause the at least one processor to perform operations comprising:
maintaining, in a tri-ledger data store, a currency ledger, an index ledger, and an energy ledger for events associated with Behavioral Economics Identities;
computing metrics for at least one segment based on entries in the tri-ledger data store;
evaluating at least one rollback energy quantity recorded in the energy ledger;
determining at least one clawback action for at least one event based on the metrics and the at least one rollback energy quantity;
generating at least one standardized clawback instruction corresponding to the at least one clawback action and formatted for an external infrastructure; and
causing updates to at least one of the currency ledger, the index ledger, and the energy ledger responsive to execution of the at least one standardized clawback instruction.

19. The non-transitory computer-readable medium of claim 18, wherein the instructions further cause the at least one processor to:
store, for each executed clawback action, a case record in an audit log separate from the tri-ledger data store, the case record comprising at least metric values used in determining the clawback action, an identifier of a legal execution node that generated the at least one standardized clawback instruction, and an identifier of a treasury node that executed at least one compensating transfer; and
digitally sign the case record so that the case record is verifiable when exported to at least one of a court, a regulator, or an external dispute resolution system.

20. The non-transitory computer-readable medium of claim 18, wherein the instructions further cause the at least one processor to periodically aggregate data from the currency ledger, the index ledger, the energy ledger, and the audit log into anonymized aggregate metrics for at least one of a city, a region, or a nation, and to provide the anonymized aggregate metrics to at least one external analysis or policy system without exposing individual Behavioral Economics Identity identifiers.
